(19) United States
(12) Patent Application Publication
(10) Pub. No.: US 2007/0075276 A1
(43) Pub. Date: Apr. 5, 2007

(54) Exposure system and method for operating an exposure system

(76) Inventors: Christoph Nolscher, Nurnberg (DE); Frank-Michael Kamm, Dresden (DE)

Correspondence Address: EDELL, SHAPIRO & FINNAN, LLC, 1901 RESEARCH BLVD., SUITE 400, ROCKVILLE, MD, 20850, US

(21) Appl. No.: 11/521,609

(22) Filed: Sep. 15, 2006

(30) Foreign Application Priority Data
Sep. 15, 2005 (DE) 102005044141.6

(51) Int. Cl. G01J 3/10

(52) U.S. Cl. 250/504 R

(57) ABSTRACT

An exposure system includes a container in which a radiation source is arranged which emits electromagnetic radiation. Furthermore, an electromagnetic trap, suitable for collecting neutral particles, is arranged inside the container. An ionization unit ionizes the neutral particles emitted during the operation of the radiation source. The electromagnetic trap collects the charged particles. Thereby, the neutral particles are removed which would otherwise impair the lithographic projection by absorption or deposition on components of the exposure system. A method is disclosed for operation of an exposure system.

### CROSS REFERENCE TO RELATED APPLICATIONS

This application claims priority under 35 U.S.C. §119 to Application No. DE 102005044141.6 filed on Sep. 15, 2005, entitled “Exposure System and Method for Operating an Exposure System,” the entire contents of which are hereby incorporated by reference.

### FIELD OF THE INVENTION

The claimed device relates to an exposure system and a method for operating an exposure system.

### BACKGROUND

Integrated circuits are produced by photolithographic projection of patterns onto semiconductor wafers. For this purpose, layers provided with various electrical properties are usually applied to semiconductor wafers and lithographically patterned in each case. A lithographic patterning step can comprise: applying a photosensitive resist, exposing with a desired pattern for the relevant layer, and developing and then transferring the resist mask thus produced into the underlying layer in an etching step.

Dense line/column patterns, formed, for example, in the field of production of dynamic random access memories (DRAMs) have structural features with line widths of 110 nm or less, for example, in the region of the memory cell arrays.

Exposure systems are used in the field of semiconductor production in order to form a pattern of structural features in the resist on a semiconductor wafer coated with a photoresist via lithographic projection. The choice of lateral extent of the structural features to be formed on the semiconductor wafer is restricted due to a lower resolution limit predetermined, in particular, by the exposure system. The resolution limit depends on many factors and is usually described in accordance with the following formula:
bₘᵢₙ=k₁×λ/NA.
In this equation λ represents the wavelength of the light source of the exposure system, NA is the numeric aperture and k₁ is a factor which depends on various contributions such as, e.g., the type of exposure, the resist layer used, the focus conditions and other parameters. To increase the resolving power of the exposure system, there are thus in principle three possibilities which will be discussed briefly in the text which follows.

The resolution limit of a projection device can be reduced, on the one hand, by using modern lithographic techniques in the masks used for the exposure. On the one hand, this relates to the field of phase masks, which are also called phase shift masks. On the other hand, various exposure modes such as, for example, oblique illumination, quadrupole illumination or annular illumination are carried out which also produce an improvement in the resolving power of the projection device. These types of illumination are also called off-axis illumination (OAI) in this technical field. In contrast to illumination which is incident perpendicularly, much higher orders of diffraction are transferred in the projection lens with oblique illumination.

As a further possibility, the so-called RET (resolution enhancement technique) methods are known in which the structural features on the mask, apart from the circuit patterns to be imaged, frequently also contain other elements which improve the resolution of the projection device. Apart from the elements for optical proximity correction (OPC) known in the field, the use of structural features below the resolution limit in the environment of structural features to be imaged is also provided.

Individually or in combination, these techniques provide for a distinct improvement in the resolving power of a projection device by a greater value for the factor k₁. However, it must be assumed that with the currently prevailing exposure wavelength of 193 nm, the possibilities for improvement can no longer be exploited to such an extent that, for example, patterning with smallest resolutions of 50 nm would be possible.

However, the resolving power can also be increased if the numeric aperture NA is increased. This is utilized, for example, in immersion lithography in which the light of the projection device is transmitted from the projection lens to the resist layer not in a vacuum but within an immersion liquid, e.g., water. It is thus possible to obtain values of greater than 1 for the numeric aperture. Together with a k₁ factor of approximately 0.3, a resolving power of 50 nm or better could thus be achieved at an exposure wavelength of 193 nm.

A third possibility for increasing the resolving power includes reducing the exposure wavelength λ. The current exposure systems for photolithography use an exposure wavelength of 193 nm, for example. There are efforts in this field to reduce the exposure wavelength to 157 nm.

Both in the 193 nm lithography and in the 157 nm lithography, e.g., deep ultraviolet lithography (DUV), a laser is used as the light source so that the reduction in exposure wavelength appears to be unproblematic at first glance. However, exposure systems having such a short wavelength are associated with some technical problems, particularly with regard to changing material properties during irradiation of, e.g., the pellicle protection foil, but still represent a possible option for future exposure technologies.

A further exposure technology to which attention is currently being paid in many types of research activities is the exposure in the so-called extreme ultraviolet range (EUV). These are wavelengths in the range of a few nm, for example 13.5 nm. Electromagnetic radiation of this wavelength is absorbed heavily by all materials so that the traditional projection lithography with lens elements must be replaced by an arrangement of highly reflective mirrors in a vacuum.

As a source for electromagnetic radiation of this wavelength, a plasma source can be considered, for example, in which a basic material is ionized several times via a laser or an electrical discharge. The electromagnetic radiation radiated is collected by a collector and transferred via the mask to the substrate provided with a resist layer which is sensitive in the EUV band.

Lithography in a vacuum makes high demands with regard to low contamination with impurities in order to achieve the lowest possible absorption. On the one hand, the power of the plasma source with respect to the amount of radiation delivered is not very high so that any additional absorption would be an impediment. On the other hand, it is also important because impurities can reduce the reflectivity of the collector.

A possible solution for eliminating impurities in EUV lithography is shown in WO-A2-2004/092693. In this document, an electrical or magnetic field is generated in the vicinity of the plasma source in order to attract and thus capture charged particles.

In the exposure systems with 157 nm wavelength, a purge with ultraclean nitrogen gas is usually performed in order to eliminate volatile components of impurities.

However, the approaches to a solution discussed above only provide for a partial elimination of the impurities in modern exposure systems.

### SUMMARY

An exposure system includes a container in which a radiation source is arranged which emits electromagnetic radiation. Furthermore, an electromagnetic trap, suitable for collecting neutral particles, is arranged inside the container. An ionization unit ionizes the neutral particles emitted during the operation of the radiation source. The electromagnetic trap collects the charged particles. Thereby, the neutral particles are removed which would otherwise impair the lithographic projection by absorption or deposition on components of the exposure system. A method is disclosed for operation of an exposure system.

In the text which follows, the claimed device will be explained, for example, with reference to an exposure system for the lithography of semiconductor structures. However, the device can also be applied to other production processes in which high-resolution structural features must be formed in a lithography step and where impurities must be avoided during the production. For example, micro- and nano-mechanical elements, which also require a very fine structural resolution and are produced with high-resolution exposure systems, can benefit from the claimed device.

The above and still further features and advantages of the present claimed device will become apparent upon consideration of the following definitions, descriptions and descriptive figures of specific embodiments thereof, wherein like reference numerals in the various figures are utilized to designate like components. While these descriptions go into specific details of the device, it should be understood that variations may and do exist and would be apparent to those skilled in the art based on the descriptions herein.

### BRIEF DESCRIPTION OF THE DRAWINGS

The invention will now be explained in greater detail with reference to the attached drawing, where:

FIG. 1A diagrammatically shows a cross-sectional view of a radiation source according to a first embodiment;

FIG. 1B diagrammatically shows a cross-sectional view of a radiation source according to a second embodiment;

FIG. 2 diagrammatically shows a cross-sectional view of an exposure system according to a first embodiment;

FIG. 3 diagrammatically shows a cross-sectional view of an exposure system according to a second embodiment; and

FIG. 4 shows a flowchart with method steps according to a first embodiment.

### DETAILED DESCRIPTION

An exposure system and a method for operating an exposure system provides for improved elimination of impurities. According to an exemplary embodiment, the exposure system for lithographic projection comprises: a container; a radiation source arranged inside the container or coupled to the container and being suitable for radiating electromagnetic radiation with a predetermined wavelength; a reticle arranged inside the container and being provided with a pattern; a substrate holder arranged inside the container and being suitable for accepting a semiconductor wafer being provided with a resist layer; projection optics arranged between the substrate holder and the reticle inside the container and projecting the electromagnetic radiation penetrating the reticle onto an image plane above the substrate holder; and an electromagnetic trap arranged inside the container and being suitable for collecting neutral particles emitted during the operation of the radiation source such that an ionization unit ionizes the neutral particles.

Impurities which are present as neutral particles are captured by the electromagnetic trap. In order to be able to collect the neutral particles, an ionization unit is provided which ionizes the neutral particles. The particles which are now charged are collected by the electromagnetic trap. According to this device, it is possible to remove neutral particles which would otherwise impair the lithographic projection due to absorption or deposition on components of the exposure system.

In one embodiment, the exposure system comprises illumination optics arranged between the reticle and the radiation source inside the container, which project the electromagnetic radiation concentrated via the radiation source onto the reticle.

It is possible to create an exposure system according to the described device which operates, for example, with a wavelength of 193 nm, 157 nm or also in the EUV range. Exposure systems in these ranges are sensitive to contamination of impurity atoms which are generated, for example, by outgassing of the components of the exposure system or of the resist layer located on the semiconductor wafer. It should be mentioned that the electromagnetic radiation of a 157 nm laser represents a possible ionization unit.

In a further embodiment, the electromagnetic trap is provided with a laser as an ionization unit which is suitable for ionizing neutral particles emitted by the plasma source in order to form the charged particles.

A laser represents a simple possibility for ionizing the neutral particles. The laser light can be selected, for example, in a wavelength band in which the resist layer is insensitive so that stray radiation of the laser light in the interior of the container cannot lead to any unwanted exposure patterns on the semiconductor wafer. Blocking out via a filter is also possible.

The light from a mercury lamp is also suitable as ionization unit and represents a simple and cost-effective possibility for ionizing the neutral particles.

In a further embodiment, the electromagnetic trap is provided with a high-frequency source as ionization unit which is suitable for ionizing neutral particles emitted by the plasma source in order to form the charged particles.

The use of a high-frequency source as ionization unit does not present any problems with regard to stray radiation of the ionization unit in the optical range.

In a further embodiment, the electromagnetic trap is a capacitor arrangement which comprises at least two electrically conductive surfaces and at least partially encloses the area of the radiation source.

The particles of the impurity or of the impurities ionized via the ionization unit are collected on one of the electrically conductive surfaces of the capacitor arrangement depending on the state of their charge such that contamination of the components of the exposure system is prevented.

In a further embodiment, the electromagnetic trap is a magnet arrangement which is arranged in the area of the radiation source, wherein at least one magnet of the magnet arrangement is arranged in the area of the radiation source.

The particles of the impurity or of the impurities ionized via the ionization unit are collected in the area of the radiation source via a magnet of the magnet arrangement such that contamination of the components of the exposure system is prevented.

In a further embodiment, the radiation source is a plasma source.

It is possible to create an exposure system according to the described device which operates in the EUV range. Exposure systems in the EUV range are particularly sensitive with regard to absorption or deposition on components by impurities.

In a further embodiment, the exposure system comprises a collector which is arranged inside the container and which concentrates the electromagnetic radiation radiated via the plasma source.

Exposure systems in the EUV range frequently require a collector. The exposure system according to the described device can also be equipped with a collector.

In a further embodiment, the electromagnetic trap is arranged in the area between the plasma source and the collector.

Impurities formed by the discharge process of the radiation source are eliminated. For example, although a plasma source mainly generates particles charged several times which, in turn, can form secondary ions which recombine with electrons so that neutral particles are produced, the neutral particles are re-ionized by the ionization unit thereby being attracted by the capacitor arrangement and removed.

In a further embodiment, the electromagnetic trap is arranged in the area between the radiation source and the illumination optics outside a beam path of the electromagnetic radiation emitted by the radiation source.

According to this embodiment, background contamination of neutral particles in the area of the illumination optics is removed via the electromagnetic trap such that the optical properties of the exposure system are retained. The contamination of non-volatile elements such as, e.g., lithium, tin, iron, chromium or hydrocarbons is prevented by this procedure.

In a further embodiment, the electromagnetic trap is arranged in the area between the reticle and the projection optics outside the electromagnetic radiation penetrating the reticle. According to this embodiment, background contamination of neutral particles in the area of the projection optics is removed via the electromagnetic trap such that the optical properties of the exposure system are retained. The contamination of non-volatile elements such as, e.g., lithium, tin, iron, chromium or hydrocarbons is prevented by this procedure.

In a further embodiment, the electromagnetic trap is arranged in the area between the projection optics and the substrate holder outside a beam path of the electromagnetic radiation concentrated by the projection optics. According to this embodiment, background contamination of neutral particles in the area of the projection optics is removed via the capacitor arrangement. This area is a strong source for contamination, particularly due to outgassing of the resist layer on the semiconductor wafer.

An exemplary method for operation of an exposure system for lithographic projection includes: providing a container; providing a radiation source arranged inside the container or coupled to the container and being suitable for radiating electromagnetic radiation with a predetermined wavelength; providing a reticle arranged inside the container and being provided with a pattern; providing a substrate holder arranged inside the container and being suitable for accepting a semiconductor wafer with a resist layer; providing projection optics arranged between the substrate holder and the reticle inside the container and being capable to project the electromagnetic radiation penetrating the reticle onto an image plane above the substrate holder; providing an ionization unit; providing an electromagnetic trap arranged inside the container and being suitable for collecting neutral particles emitted during the operation of the radiation source in that the neutral particles are ionized by the ionization unit; and applying a voltage thereby generating a potential difference between at least two electrically conductive surfaces or generating a magnetic field of a coil of the electromagnetic trap.

Exemplary embodiments of the exposure system and methods of operations will now be described in connection with the figures.

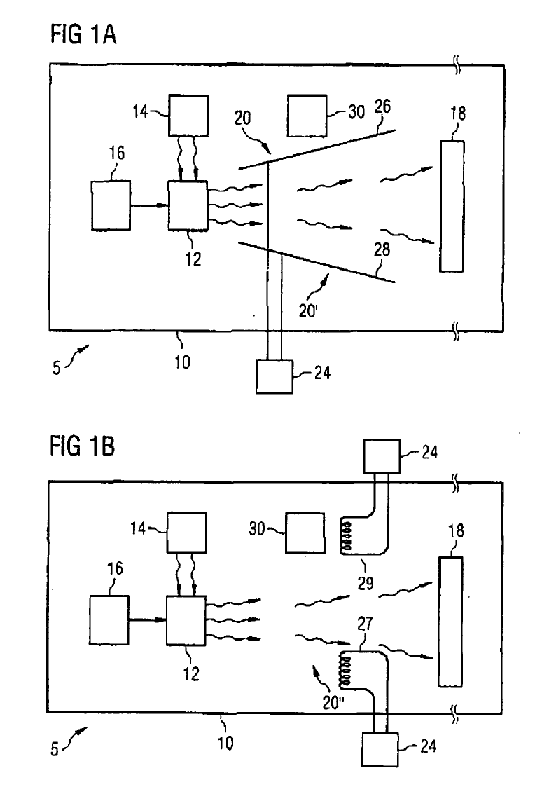

FIG. 1A shows a first embodiment of the device. The exposure system 5 shown diagrammatically in FIG. 1A is intended for lithographic projection in a vacuum. For this purpose, the exposure system 5 is enclosed by a container 10 which is evacuated in order to generate a high vacuum. Arranged inside the container 10 is a radiation source 12. The radiation source 12 radiates electromagnetic radiation with a predetermined wavelength in the EUV band. However, it is also conceivable that the radiation source 12 is coupled to the container 10, for example, via a flange or a suitable entry window (not shown in FIG. 1A).

A plasma source is usually used for the radiation source 12 in the EUV range. The plasma source as radiation source 12 emits electromagnetic radiation with a wavelength of less than 30 nm. The emission takes place via multiple ionization of a base material in the plasma source. The base material is transferred to the radiation source 12 by a feeding device 16.

The base material used for the plasma source can be xenon, lithium or tin but other materials known to the expert and suitable for use in the plasma source are naturally not excluded.

In the radiation source 12, the base material is ionized, for example, ten times. The multiple ionization of the base material is performed, for example, by laser light of a first ionization stage 14 which is drawn diagrammatically in FIG. 1A. It is also possible to ionize the base material of the plasma source via discharge in the first ionization stage 14.

The electromagnetic radiation radiated by the radiation source 12 with, for example, a wavelength of 13.5 nm is concentrated by a collector 18 which is also arranged inside the container 10. The collector 18 is formed, for example, by a mirror which reflects the electromagnetic radiation towards the other components of the exposure system.

Accordingly, the exposure system 5 has other components arranged inside the container 10. Thus, for example, a reticle provided with a pattern, illumination optics, a substrate holder for accepting a semiconductor wafer provided with a resist layer and projection optics which are arranged between the substrate holder and the reticle and which project the electromagnetic radiation penetrating the reticle onto an image plane above the substrate holder are provided as further components. The projection optics is, for example, a highly reflective mirror.

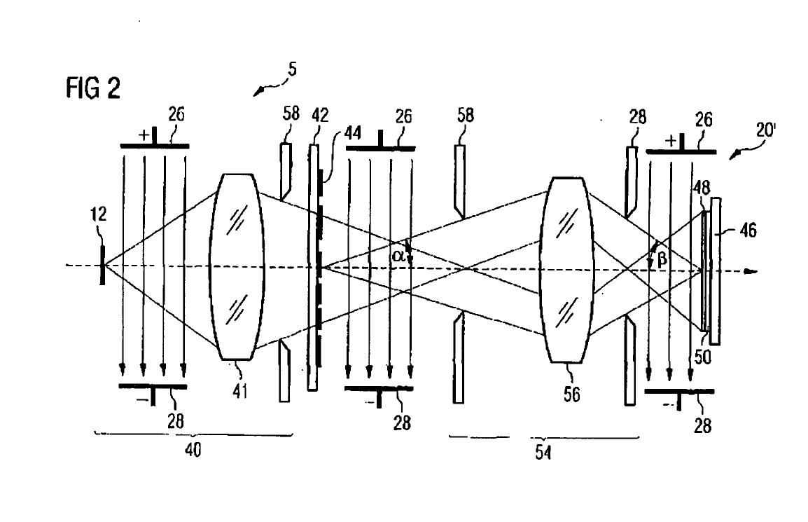

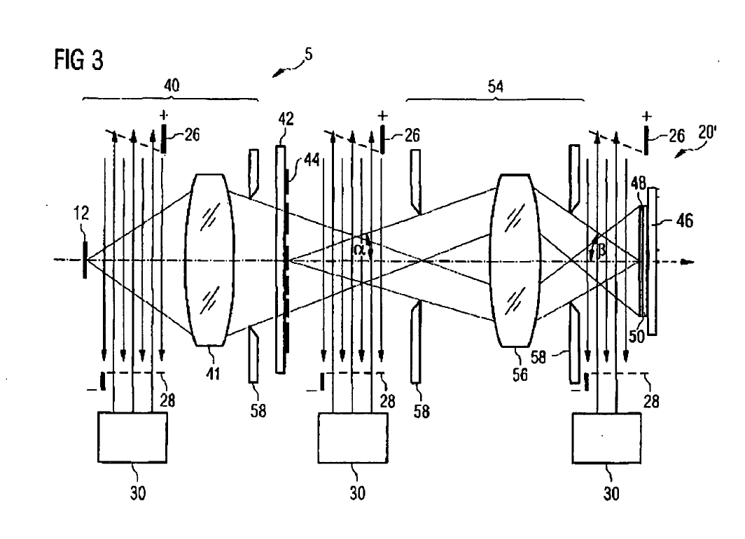

These components of the exposure system 5 are not shown in FIG. 1A but are explained in the embodiments according to FIGS. 2 and 3 so that reference is made appropriately to these points in the description.

Furthermore, the exposure system 5 has an electromagnetic trap 20. In the exemplary embodiment shown in FIG. 1A, this electromagnetic trap 20 is a capacitor arrangement which is provided with reference symbol 20′. The capacitor arrangement 20′ is provided with two electrically conductive surfaces. The electrically conductive surfaces are connected to a voltage source 24 so that the first electrically conductive surface forms an anode 26 and the second electrically conductive surface forms a cathode 28.

The anode 26 and the cathode 28 of the capacitor arrangement 20′ are also arranged inside the container 10. The capacitor arrangement 20′ is mounted in the area between the plasma source of the radiation source 12 and the collector 18 so that the anode 26 and the cathode 28 of the capacitor arrangement 20′ enclose the area between the plasma source and the collector 18.

In a second embodiment, the electromagnetic trap 20 is a magnet arrangement 20″ which is shown in FIG. 1B instead of the capacitor arrangement.

In this example, the magnet arrangement 20″ comprises a first coil 27 which is arranged above the radiation source 12, and a second coil 29 which is arranged on the side of the beam path from the plasma source to the collector opposite to the first coil. The first coil 27 and the second coil 29 in each case form an electromagnet, the magnetic field of which attracts the charged particles. The first coil 27 and the second coil 29 are in each case individually connected to a voltage source 24. Naturally, the first coil 27 and the second coil 29 can also be connected to a common voltage source.

The capacitor arrangement 20′ or the magnet arrangement 20″ of the electromagnetic trap 20 has the task of collecting neutral particles emitted during the operation of the radiation source 12. For this purpose, an ionization unit 30 is provided which ionizes the neutral particles. The ionization unit 30 can also be called a second ionization stage but only produces single or double ionization of the neutral particles in contrast to the first ionization stage 14.

Various embodiments, which are presented in the text which follows, are conceivable as ionization unit 30.

In a first example, the electromagnetic trap 20 is provided with a laser as ionization unit 30. The laser of the ionization unit 30 ionizes the neutral particles emitted by the radiation source so that charged particles are formed which are attracted by the anode 26 or the cathode 28, respectively, and are thus removed.

The laser of the ionization unit 30 emits, for example, light with a wavelength of more than 300 nm. In addition, it is provided that the laser of the ionization unit 30 has a filter which absorbs light in a wavelength range in which the resist layer on a semiconductor wafer in the exposure system 5 is light sensitive. For example, an excimer laser can be used.

In a second example, the electromagnetic trap 20 is provided with a mercury lamp as ionization unit 30 which is capable of forming charged particles. In a third example, the electromagnetic trap 20 is provided with a high-frequency source as ionization unit 30 which ionizes neutral particles emitted by the plasma source in order to form the charged particles.

The electrically conductive surfaces of the capacitor arrangement 20′, i.e., the anode 26 and the cathode 28, respectively, can be constructed, for example, as solid metal plates. It is also conceivable that the electrically conductive surfaces of the capacitor arrangement 20′ of the electromagnetic trap 20 are structured, for example, as a grid so that the electrical field of the high-frequency source as ionization unit 30 or the light of the mercury lamp or of the excimer laser can be supplied to the area between the electrically conductive surfaces in a simple manner.

To collect the charged particles between the anode 26 and the cathode 28 of the capacitor arrangement 20′ of the electromagnetic trap 20, the potential difference of the voltage source 24 can be selected within a range of between 10 V and 10 kV depending on the geometry of the exposure system.

The embodiments of the exposure system 5 presented in conjunction with FIGS. 1A and 1B essentially eliminate impurities in the area of the radiation source 12 which operates in the EUV range.

In the text which follows, two embodiments of the invention are presented which, in particular, eliminate the background contamination via outgassing substances. The measures presented can also be used as an alternative or additionally to the cleaning in the area of the radiation source 12 described above.

FIG. 2 again shows diagrammatically the exposure system 5 for the lithographic projection in a vacuum. For this purpose, the exposure system 5 is enclosed by the container (not shown in FIG. 2).

The radiation source 12 is arranged inside the container. The radiation source 12 radiates electromagnetic radiation having a predetermined wavelength which, in the present example, can be in the DUV band at 157 nm.

In the DUV band, a laser is usually used for the radiation source 12. The electromagnetic radiation radiated by the radiation source 12 is concentrated by illumination optics 40 which are also arranged inside the container. The illumination optics 40 comprises, for example, a lens 41 which collects the light from the radiation source 12.

In addition, the exposure system 5 has a reticle 42 which is provided with a pattern 44 to be projected on the side facing away from the illumination optics 40. In addition, a substrate holder 46 for accepting a semiconductor wafer 50 provided with a resist layer 48 is provided.

Projection optics 54 is arranged between the substrate holder 46 and the reticle 42. The projection optics 54 comprise, for example, a lens 56 which projects the light of the radiation source 12 penetrating the reticle 42 onto an image plane above the substrate holder 46 at the position of the resist layer 48. Furthermore, diaphragms 58 are mounted in the area of the projection optics 54 and the illumination optics 40 as normal with lithographic projection systems.

The exposure system 5 according to FIG. 2 also has a capacitor arrangement 20′. The capacitor arrangement 20′ is again provided with two electrically conductive surfaces within the container, which form the anode 26 and the cathode 28 of the capacitor arrangement 20′. However, it is also conceivable to use the magnet arrangement 20″ instead of the capacitor arrangement 20′ or in addition to the capacitor arrangement 20′.

In the present example, the capacitor arrangement 20′ is mounted in the area between the radiation source 12 and the illumination optics 40, between the reticle 42 and the projection optics 54 and between the projection optics 54 and the substrate holder 46. The anode 26 and the cathode 28 of the capacitor arrangement 20′ enclose this area without, however, shadowing the beam path from the radiation source 12 to the substrate holder 46. It should also be mentioned that the capacitor arrangement 20′ can be mounted only in parts of areas or can be omitted completely in certain areas.

In order to collect the charged particles between the anode 26 and the cathode 28 of the capacitor arrangement 20′, the potential difference of the voltage source 24 can again be selected in a range between 10 V and 10 kV depending on the geometry of the exposure system.

In contrast to the embodiment according to FIG. 1, the radiation source 12 itself provides the ionization of neutral particles in the present example. Light with a wavelength of 157 nm leads to the ionization of neutral particles which can be produced via: outgassing, removal of material, or contamination inside the container.

The embodiment of the exposure system 5 presented in conjunction with FIG. 2 essentially eliminates impurities in the entire area of the exposure system 5 which are produced, for example, by outgassing substances. In this arrangement, the ionizing capability of the radiation source 12 is utilized so that no additional devices need to be provided for the ionization of neutral particles.

In conjunction with FIG. 3, the elimination of impurities in the entire area of the exposure system 5 is extended by the ionization unit 30 according to FIGS. 1A and 1B as a result of which the elimination of the impurities can be improved even further.

FIG. 3 again diagrammatically shows the exposure system 5 for the lithographic projection. The exposure system 5 has the same structure as the exposure system according to FIG. 2.

The capacitor arrangement 20′ is again mounted in the area between the radiation source 12 and the illumination optics 40, between the reticle 42 and the projection optics 54 and between the projection optics 54 and the substrate holder 46. It is also conceivable to use the magnet arrangement 20″ instead of the capacitor arrangement 20′ or in addition to the capacitor arrangement 20′.

Additionally, the ionization unit 30 is now mounted directly above the area between the radiation source 12 and the illumination optics 40, between the reticle 42 and the projection optics 54 and between the projection optics 54 and the substrate holder 46.

The capacitor arrangement 20′ collects neutral particles which are ionized by the ionization unit 30. As already specified above, the ionization unit 30 can be formed as laser which emits light with a wavelength of more than 300 nm, as a mercury lamp or high-frequency source, in order to form the charged particles.

The electrically conductive surfaces of the capacitor arrangement 20′, i.e., the anode 26 and the cathode 28, respectively, can again be constructed structured as solid metal plates or as grids.

In a further embodiment, it is possible to operate the exposure system with a purge gas, i.e., rather than evacuate the container 10. This is frequently carried out for cleaning purposes in exposure systems of the 193 nm line, using, for example, ultra pure nitrogen as purge gas. In this case, the ionization unit 30 must ionize the neutral particles selectively with respect to the purge gas. This can be done, for example, via a laser. The energy delivery of the laser is selected such that only, or to a large degree only, the neutral particles are ionized.

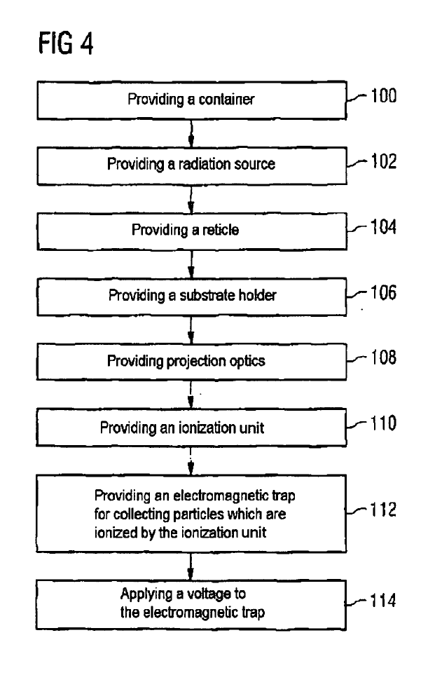

Referring to FIG. 4, a method for operating the exposure system 5, the method procedures of which are shown in a flowchart, will be described in the text which follows.

In procedure 100, the container is provided.

In procedure 102, a radiation source is provided which is arranged inside the container and is suitable for radiating electromagnetic radiation with a predetermined wavelength.

In procedure 104, a reticle is provided which is arranged inside the container and which is provided with a pattern.

In procedure 106, a substrate holder is provided which is arranged inside the container and which is suitable for accepting a semiconductor wafer with a resist layer.

In procedure 108, projection optics are provided which are arranged between the substrate holder and the reticle inside the container and which project the electromagnetic radiation penetrating the reticle onto an image plane above the substrate holder.

In procedure 110, an ionization unit is provided.

In procedure 112, an electromagnetic trap is provided which is arranged inside the container and which is suitable for collecting neutral particles emitted during the operation of the radiation source in that the neutral particles are ionized by the ionization unit.

Subsequently, a voltage is applied in procedure 114 generating a potential difference between at least two electrically conductive surfaces or a magnetic field of a coil of the electromagnetic trap.

List of Reference Symbols

5 Exposure system
10 Container
12 Radiation source
14 First ionization stage
16 Feeding device
18 Collector
20 Electromagnetic trap
22′ Capacitor arrangement
20″ Magnet arrangement
24 Voltage source
26 Anode
27 First coil
28 Cathode
29 Second coil
30 Ionization unit
40 Illumination optics
41 Lens
42 Reticle
44 Pattern
46 Substrate holder
48 Resist layer
50 Semiconductor wafer
54 Projection optics
56 Lens
58 Diaphragms
100-114 Method procedures

What is claimed is:

1. An exposure system for lithographic projection, comprising:
a container;
a radiation source arranged inside the container and being suitable for radiating electromagnetic radiation with a predetermined wavelength;
a reticle arranged inside the container and being provided with a pattern;
a substrate holder arranged inside the container and being suitable for accepting a semiconductor wafer including a resist layer;
projection optics arranged between the substrate holder and the reticle inside the container and being suitable for projecting the electromagnetic radiation penetrating the reticle onto an image plane above the substrate holder; and
an electromagnetic trap comprising an ionization unit;
wherein the electromagnetic trap is arranged inside the container and is suitable for collecting neutral particles emitted during operation of the radiation source, and wherein the neutral particles are ionized via the ionization unit.

2. The exposure system as claimed in claim 1, further comprising:
illumination optics arranged between the reticle and the radiation source inside the container and being suitable for projecting the electromagnetic radiation concentrated by the radiation source onto the reticle.

3. The exposure system as claimed in claim 1, wherein the ionization unit comprises a laser suitable for ionizing neutral particles emitted by the radiation source, thereby forming charged particles.

4. The exposure system as claimed in claim 3, wherein the laser emits light with a wavelength of more than 300 nm.

5. The exposure system as claimed in claim 3, wherein the laser comprises a filter that absorbs light in a wavelength range in which the resist layer is light sensitive.

6. The exposure system as claimed in claim 3, wherein the laser is an excimer laser.

7. The exposure system as claimed in claim 3, wherein the laser is a pulsed laser.

8. The exposure system as claimed in claim 3, wherein the ionization unit comprises a high-frequency source suitable for ionizing neutral particles emitted by the radiation source, thereby forming charged particles.

9. The exposure system as claimed in claim 8, wherein the electromagnetic trap comprises a capacitor arrangement that comprises at least two electrically conductive surfaces and at least partially encloses an area of the radiation source.

10. The exposure system as claimed in claim 9, wherein the electrically conductive surfaces are structured such that the electrical field of the high-frequency source penetrates into an area between the electrically conductive surfaces.

11. The exposure system as claimed in claim 9, wherein the electrically conductive surfaces are structured such that light from the laser penetrates into an area between the electrically conductive surfaces.

12. The exposure system as claimed in claim 9, wherein a first one of the at least two electrically conductive surfaces is connected as an anode and a second one of the at least two electrically conductive surfaces is connected as a cathode.

13. The exposure system as claimed in claim 12, wherein a potential difference between the anode and the cathode is between 10 V and 10 kV.

14. The exposure system as claimed in claim 1, wherein the electromagnetic trap comprises a magnet arrangement that is arranged in proximity to the radiation source, wherein at least one magnet of the magnet arrangement is arranged in proximity to the radiation source.

15. The exposure system as claimed in claim 14, wherein the magnet is an electromagnet.

16. The exposure system as claimed in claim 1, wherein the container is at least partially evacuated.

17. The exposure system as claimed in claim 1, wherein the radiation source is a plasma source.

18. The exposure system as claimed in claim 17, further comprising a collector arranged inside the container and which concentrates the electromagnetic radiation radiated by the plasma source.

19. The exposure system as claimed in claim 18, further comprising:
illumination optics arranged between the reticle and the radiation source inside the container and being suitable for projecting the electromagnetic radiation concentrated by the radiation source onto the reticle,
wherein the electromagnetic trap is further arranged in the area between the collector and the illumination optics outside a beam path of the electromagnetic radiation emitted by the radiation source.

20. The exposure system as claimed in claim 17, wherein the plasma source emits electromagnetic radiation with a wavelength of less than 30 nm, and wherein the emission of the electromagnetic radiation occurs via a multiple ionization of a base material in the plasma source.

21. The exposure system as claimed in claim 20, wherein the base material comprises one of: xenon, lithium and tin.

22. The exposure system as claimed in claim 20, wherein the multiple ionization of the base material is produced via one of: a laser light and a discharge.

23. The exposure system as claimed in claim 17, wherein the radiation source emits electromagnetic radiation with a wavelength of 193 nm or less.

24. The exposure system as claimed in claim 23, wherein the radiation source emits electromagnetic radiation with a wavelength of 157 nm or less.

25. The exposure system as claimed in claim 23, wherein the radiation source emits electromagnetic radiation with a wavelength of less than 15 nm.

26. The exposure system as claimed in claim 23, wherein the container is evacuated.

27. The exposure system as claimed in claim 23, wherein the container is filled with a purge gas.

28. The exposure system as claimed in claim 27, wherein the purge gas is ultra pure nitrogen.

29. The exposure system as claimed in claim 27, wherein the ionization unit is suitable for ionizing the neutral particles selectively with respect to the purge gas.

30. The exposure system as claimed in claim 1, wherein the electromagnetic trap is further arranged in the area between the reticle and the projection optics outside of the electromagnetic radiation penetrating the reticle.

31. The exposure system as claimed in claim 1, wherein the electromagnetic trap is further arranged in the area between the projection optics and the substrate holder outside a beam path of the electromagnetic radiation concentrated by the projection optics.

32. A method for operating an exposure system for lithographic projection, comprising:
providing a container;
providing a radiation source arranged inside the container or coupled to the container and suitable for radiating electromagnetic radiation with a predetermined wavelength;
providing a reticle arranged inside the container and provided with a pattern;
providing a substrate holder arranged inside the container and suitable for accepting a semiconductor wafer with a resist layer;
providing projection optics arranged inside the container between the substrate holder and the reticle and suitable for projecting the electromagnetic radiation penetrating the reticle onto an image plane above the substrate holder;
providing an ionization unit;
providing an electromagnetic trap arranged inside the container and suitable for collecting neutral particles emitted during the operation of the radiation source, and wherein the neutral particles are ionized via the ionization unit; and
applying a voltage, thereby generating a potential difference, the voltage being applied between at least two electrically conductive surfaces or a magnetic field of a coil of the electromagnetic trap.

33. The method as claimed in claim 32, wherein the container is evacuated.
